(19) United States
(12) Patent Application Publication
(10) Pub. No.: US 2002/0051016 A1
(43) Pub. Date: May 2, 2002

(54) Graphics drawing device of processing drawing data including rotation target object and non-rotation target object

(75) Inventors: Shohei Moriwaki, Hyogo (JP); Shunichi Yoshida, Hyogo (JP); Kingo Wakimoto, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/932,970

(22) Filed: Aug. 21, 2001

(30) Foreign Application Priority Data
Nov. 1, 2000 (JP) 2000-334728

(51) Int. Cl. G06T 3/60

(52) U.S. Cl. 345/765

(57) ABSTRACT

A geometrical arithmetic unit obtains display coordinate data by coordinate transformation of drawing data, transfers the display coordinate data to the drawing unit when the drawing data is rotation target drawing data, and transfers the display coordinate data to a processor when the drawing data is non-rotation target drawing data. A processor controls transfer of an image of the non-rotation target drawing data to the drawing memory based on the display coordinate data. A drawing unit produces a rotated image based on the rotation target drawing data, and transfers the rotated image to the drawing memory based on the display coordinate data. Therefore, the processor and the drawing unit can perform the processing in parallel so that the drawing processing speed can be increased, and the drawing processing can be performed smoothly.

### BACKGROUND OF THE INVENTION

1. Field of the Invention

The present invention relates to a technique for drawing target objects (i.e., objects to be drawn), and particularly relates a graphics drawing device of processing drawing data including a rotation target object (i.e., an object to be rotated) and a non-rotation target object (i.e., an object not to be rotated).

2. Description of the Background Art

In recent years, graphics drawing devices which can perform fast processing of three-dimensional images to output realistic and detailed images have been utilized in a car navigation system and others. In the car navigation system provided with a conventional graphics drawing device, when drawn map data (which will be referred to as “rotation target drawing data” hereinafter) is to be rotated in accordance with movement of a car, processing is performed to rotate only the rotation target drawing data without rotating additional drawn object data (which will be referred to as “non-rotation target drawing data” hereinafter) such as icons and characters arranged on the rotation target drawing data.

FIGS. 1A-1C show processing for rotating rotation target objects clockwise by 90 degrees. If rotation target drawing data 102a and non-rotation target drawing data 103a, which are present on a display screen 101 as shown in FIG. 1A, were both rotated for drawing, these rotation target drawing data 102b and non-rotation target drawing data 103b would be represented as shown in FIG. 1B. However, a user could not easily recognize the non-rotation target drawing data if it were rotated. Therefore, the processing is actually performed to rotate only rotation target drawing data 102a without rotating non-rotation target drawing data. FIG. 1C shows rotation target drawing data 102a, which are presented as rotated images, as well as non-rotation target drawing data 103c, which are represented as images in new positions without being rotated.

A conventional graphics drawing device is provided with a two-dimensional (2-D) drawing engine for drawing two-dimensional graphics and a three-dimensional (3-D) engine for drawing three-dimensional graphics. The 2-D drawing engine is formed of a processor. When drawing the map data described above, the processor forming the 2-D drawing engine primarily performs the drawing processing. For rotating the image to be drawn, the processor performs arithmetic on coordinates of the rotation target object and non-rotation target object, and thereby performs the drawing processing.

However, the conventional graphics drawing device performs the coordinate arithmetic relating to the rotation target objects and non-rotation target objects as well as the drawing processing, as described above. Therefore, the drawing speed of the processor is low, and smooth drawing cannot be performed.

### SUMMARY OF THE INVENTION

An object of the invention is to provide a graphics drawing device, which can process drawing data including rotation target drawing data and non-rotation target drawing data at an improved speed.

Another object of the invention is to provide a graphics drawing device, in which a two-dimensional drawing engine can be eliminated.

According to an aspect of the invention, a graphics drawing device for drawing graphics from drawing data including rotation target drawing data and non-rotation target drawing data, includes a drawing memory for storing an image to be drawn on a screen, a processor for controlling transfer of an image of the non-rotation target drawing data to the drawing memory based on display coordinate data, a drawing unit for producing a rotated image based on the rotation target drawing data, and transferring the rotated image to the drawing memory based on the display coordinate data, a geometrical arithmetic unit for obtaining the display coordinate data by coordinate transformation of the drawing data, transferring the display coordinate data to the drawing unit when the drawing data is the rotation target drawing data, and transferring the display coordinate data to the processor when the drawing data is the non-rotation target drawing data, and a display unit for displaying the image stored in the drawing memory on the screen.

The geometrical arithmetic unit transfers the display coordinate data to the drawing unit when the drawing data is the rotation target drawing data, and transfers the display coordinate data to the processor when the drawing data is the non-rotation target drawing data. Therefore, the processor and the drawing unit can perform the processing in parallel so that the drawing processing speed can be increased, and the drawing processing can be performed smoothly.

According to another aspect of the invention, a graphics drawing device for drawing graphics from drawing data including rotation target drawing data and non-rotation target drawing data, includes a drawing memory for storing an image to be drawn on a screen, a geometrical arithmetic unit for setting a Z-coordinate value of the drawing data to a predetermined value, and thereafter obtaining display coordinate data by coordinate transformation, a drawing unit for operating to produce a rotated image based on the rotation target drawing data, and transfer the rotated image to the drawing memory based on the display coordinate data when the drawing data is the rotation target drawing data, and operating to transfer an image corresponding to the non-rotation target drawing data to the drawing memory based on the display coordinate data when the drawing data is the non-rotation target drawing data, and a display unit for displaying the image stored in the drawing memory on the screen.

Accordingly, the drawing unit can draw images of the rotation target drawing data and non-rotation target drawing data such as map data, using 3-D drawing data.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A-1C show processing of rotating a rotation target object clockwise by 90 degrees;

FIG. 2 is a block diagram showing a schematic structure of the graphics drawing device of the first embodiment of the invention;

FIG. 3 is a block diagram showing structures of a geometrical arithmetic unit 5 and a drawing unit 6 shown in FIG. 2 in greater detail;

FIGS. 4 to 11 are block diagrams showing schematic structures of graphics drawing devices of second to ninth embodiments of the invention, respectively;

FIG. 12 is a block diagram showing structures of a geometrical arithmetic unit 15 and drawing unit 6 shown in FIG. 11 in greater detail; and

FIGS. 13 to 19 are block diagrams showing schematic structures of graphics drawing devices of tenth to sixteenth embodiments of the invention, respectively.

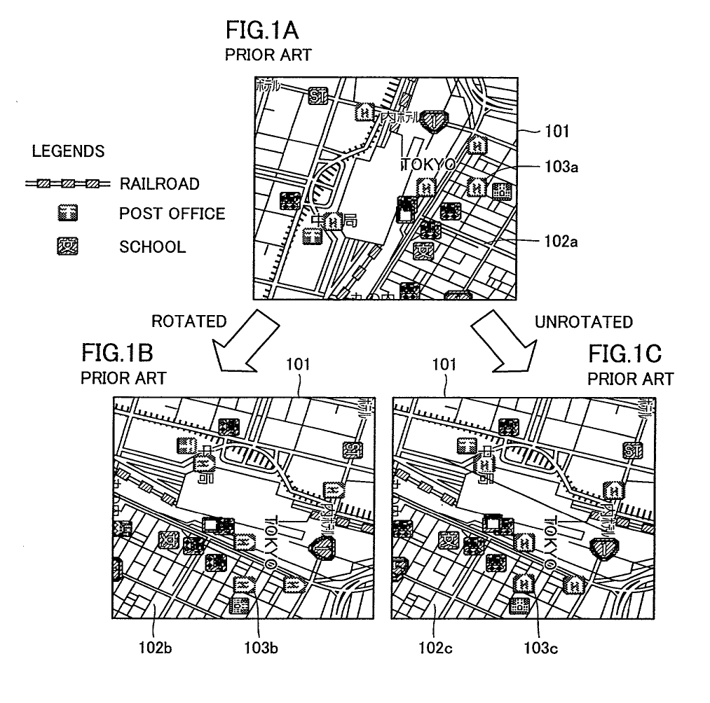

### DESCRIPTION OF THE PREFERRED EMBODIMENTS

(First Embodiment)

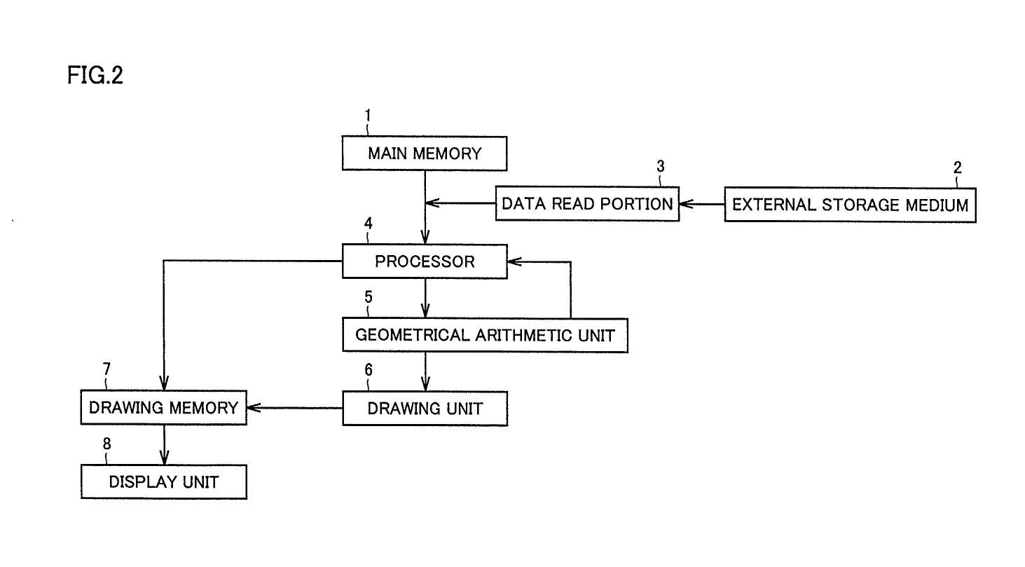

FIG. 2 is a block diagram showing a schematic structure of a graphics drawing device of a first embodiment of the invention. The graphics drawing device includes a main memory 1 for storing programs and others, a data read portion 3 for reading drawing data from an external storage medium 2, a processor 4 for executing the program stored in main memory 1 to perform a series of processing, a geometrical arithmetic unit 5 for performing geometrical arithmetic such as rotation and coordinate transformation on the drawing data sent from processor 4, a drawing unit 6 for performing a series of drawing processing based on vertex data, which is output from geometrical arithmetic unit 5 after being subjected to the arithmetic processing, a drawing memory 7 for storing, as frame images, pixel data which corresponds to the non-rotation target drawing data transferred by processor 4 and the rotation target drawing data produced by drawing unit 6, and a display unit 8 for displaying the pixel data stored in drawing memory 7.

It is assumed that the graphics drawing device of this embodiment uses the rotation target drawing data and non-rotation target drawing data, all of which are represented as 2-D drawing data, and thus are represented by X-coordinate values and Y-coordinate values.

External storage medium 2 may be a CD-ROM (Compact Disc-Read Only Memory), magneto-optical disk, a memory card or the like.

Data read portion 3 is a mechanism for reading the drawing data from external storage medium 2, and is a CD-ROM drive if external storage medium 2 is a CD-ROM.

Processor 4 transfers the drawing data and viewpoint information, which are read by data read portion 3, to geometrical arithmetic unit 5. Geometrical arithmetic unit 5 performs a series of two-dimensional projection arithmetic such as coordinate transformation based on the drawing data and the viewpoint information. Geometrical arithmetic unit 5 transfers the display coordinate data to drawing unit 6 when its operation result (which will be referred to as “display coordinate data” hereinafter) corresponds to the rotation target drawing data. Geometrical arithmetic unit 5 transfers the display coordinate data of non-rotation target drawing data to processor 4 when the display coordinate data corresponds to the non-rotation target drawing data.

When processor 4 receives the display coordinate data of non-rotation target drawing data from geometrical arithmetic unit 5, processor 4 reads the non-rotation target drawing data of bit images or the like from external storage medium 2 via data read portion 3, and writes the non-rotation target drawing data into the region of drawing memory 7 corresponding to the display coordinate data.

Drawing unit 6 produces pixel data of each polygon forming a primitive based on the display coordinate data of rotation target drawing data output from geometrical arithmetic unit 5, and writes it into drawing memory 7. When drawing unit 6 writes the pixel data corresponding to the rotation target drawing data for one frame, and processor 4 writes the non-rotation target drawing data, display unit 8 reads out the pixel data from drawing memory 7, and successively displays it.

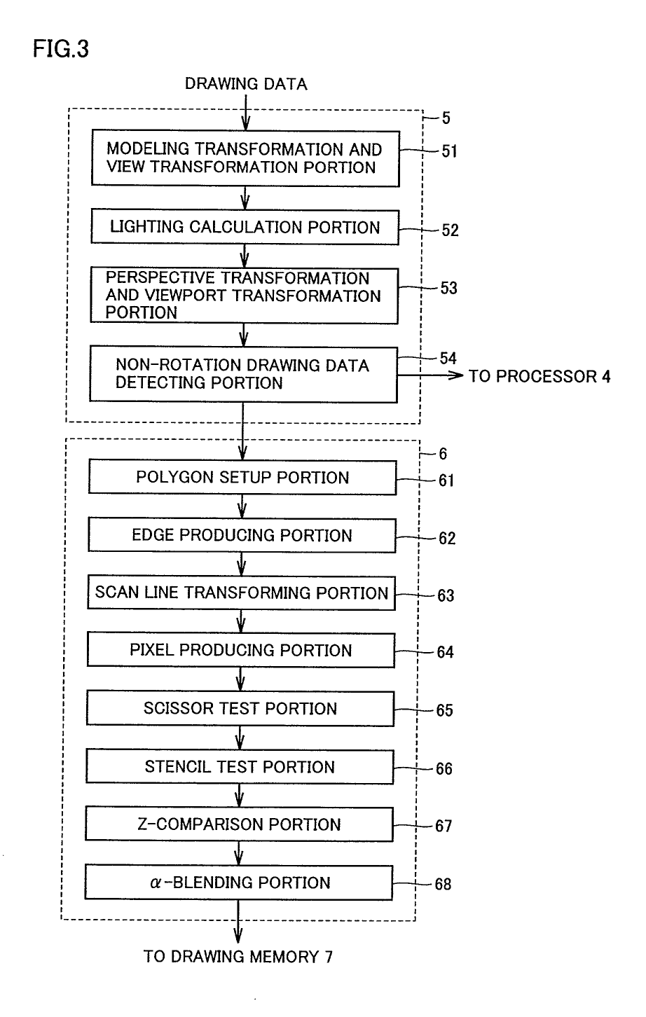

FIG. 3 is a block diagram showing geometrical arithmetic unit 5 and drawing unit 6 shown in FIG. 2 in greater detail. Geometrical arithmetic unit 5 includes a modeling transformation and view transformation portion 51, which defines the three-dimensional form to be drawn on a modeling coordinate system, transforms the three-dimensional form defined on this modeling coordinate system into that on a world coordinate system for arrangement in a space, determines projection conditions such as a position of a viewpoint and a direction of an axis of sighting with respect to the three-dimensional form, and thereby transforms the form into the three-dimensional form in the view region. Geometrical arithmetic unit 5 further includes a lighting calculation portion 52 for calculating a brightness of lighting of the three-dimensional form, which is already subjected to the modeling transformation and view transformation by modeling transformation and view transformation portion 51. Geometrical arithmetic unit 5 further includes a perspective transformation and viewport transformation portion 53 for performing perspective transformation on the three-dimensional form of the target to transform the view region to a viewport, and a non-rotation drawing data detecting portion 54 for detecting non-rotation drawing data in the drawing data, and transferring the same to processor 4.

Drawing unit 6 includes a polygon setup portion 61 for calculating differences between vertex coordinates of polygons, and outputting inclinations between the vertexes of the polygons, an edge producing portion 62 which refers to the inclinations between the vertexes of the polygons output from polygon setup portion 61, and produces the edges between the vertexes of the polygons, a scan line transforming portion 63 for transforming each polygon in units of pixel based on the edge of the polygon produced by edge producing portion 62, a pixel producing portion 64 for producing the pixel data of each polygon, a scissor test portion 65 for removing pixels which cannot be located within a display frame, a stencil test portion 66 for determining whether each pixel is a draw target or not, a Z-comparison portion 67 for making comparison relating to a Z-value of the polygon, and determining whether it is a polygon to be drawn on the display screen or not, and an a-blending portion 68 for combining color data of the underlying and overlying polygons with reference to an a value representing transparency.

Geometrical arithmetic unit 5 uses a command for providing a drawing instruction to drawing unit 6. This command defines which one among a point, a polygon or a line is the drawing target (i.e., an object to be drawn). Rotation target drawing data (map data) is defined as a polygon, and non-rotation target drawing data is defined as a point (origin coordinates forming a reference for drawing an icon or the like). When a polygon is defined in a command output from perspective transformation and viewport transformation portion 53, non-rotation drawing data detecting portion 54 determines this command as rotation target drawing data, and transfers it to drawing unit 6. When a point is defined in a command output from perspective transformation and viewport transformation portion 53, and the Z-coordinate value is “0”, non-rotation drawing data detecting portion 54 determines this command as non-rotation target drawing data, and transfers it to processor 4. The Z-coordinate value is information representing a depth, and is generally defined as “0” for map data as well as icons and characters displayed thereon. Therefore, the determination is also performed on the Z-coordinate value.

In the graphics drawing device of this embodiment, as described above, non-rotation drawing data detecting portion 54 transfers the non-rotation target drawing data to processor 4 when a point is defined in a command. Also, non-rotation drawing data detecting portion 54 transfers the rotation target drawing data to drawing unit 6 when a polygon is defined in a command. Therefore, processing on the rotation target drawing data and processing on the non-rotation target drawing data can be performed in parallel so that the drawing processing speed can be increased, and the drawing processing can be performed smoothly. Since data read portion 3 reads the drawing data stored in external storage medium 2, it is possible to read various kinds of drawing data by changing external storage medium 2.

(Second Embodiment)

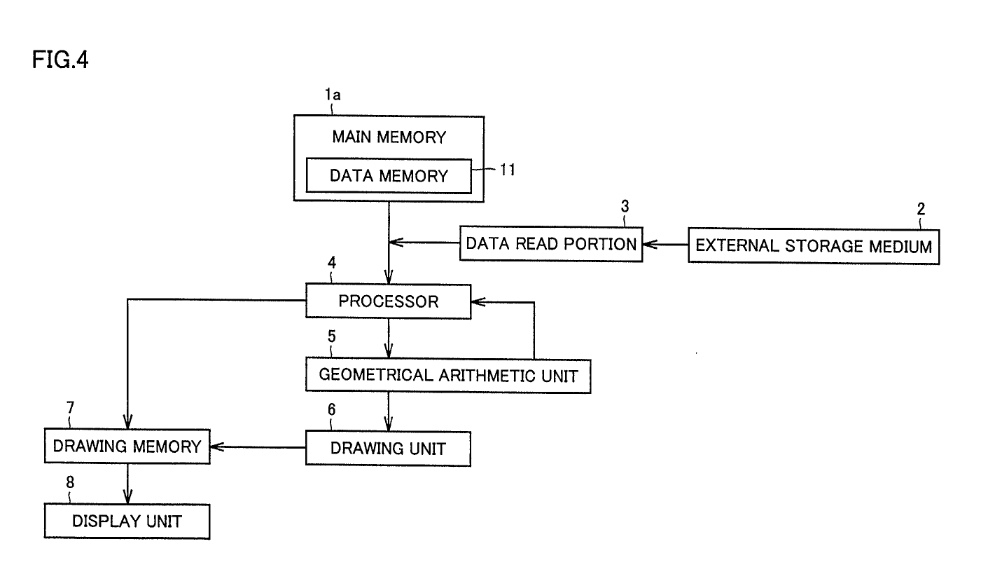

FIG. 4 is a block diagram showing a schematic structure of a graphics drawing device of a second embodiment of the invention. The graphics drawing device of this embodiment differs from the graphics drawing device of the first embodiment shown in FIG. 2 only in the structure of the main memory. Accordingly, description of the same structures and functions is not repeated. In the following description of this embodiment, the main memory is indicated by a reference number 1a.

Main memory 1a includes a data memory 11 for temporarily storing drawing data read from external storage medium 2, in addition to the region for storing a program to be executed by processor 4. Processor 4 temporarily stores the drawing data, which is read via data read portion 3, in data memory 11. Processor 4 appropriately reads the drawing data from data memory 11, and transfers it to geometrical arithmetic unit 5. Further, processor 4 receives a command corresponding to the non-rotation target drawing data from geometrical arithmetic unit 5, and thereby reads the non-rotation target drawing data stored in data memory 11 for transferring it to drawing memory 7.

According to the graphics drawing device of this embodiment, as described above, the drawing data is read from external storage medium 2, and is temporarily stored in data memory 11. Therefore, the subsequent access for the drawing data is made to data memory 11 so that fast reading of the drawing data can be performed. Compared with the graphics drawing device of the first embodiment, therefore, the drawing processing speed can be further improved, and the drawing processing can be performed further smoothly.

(Third Embodiment)

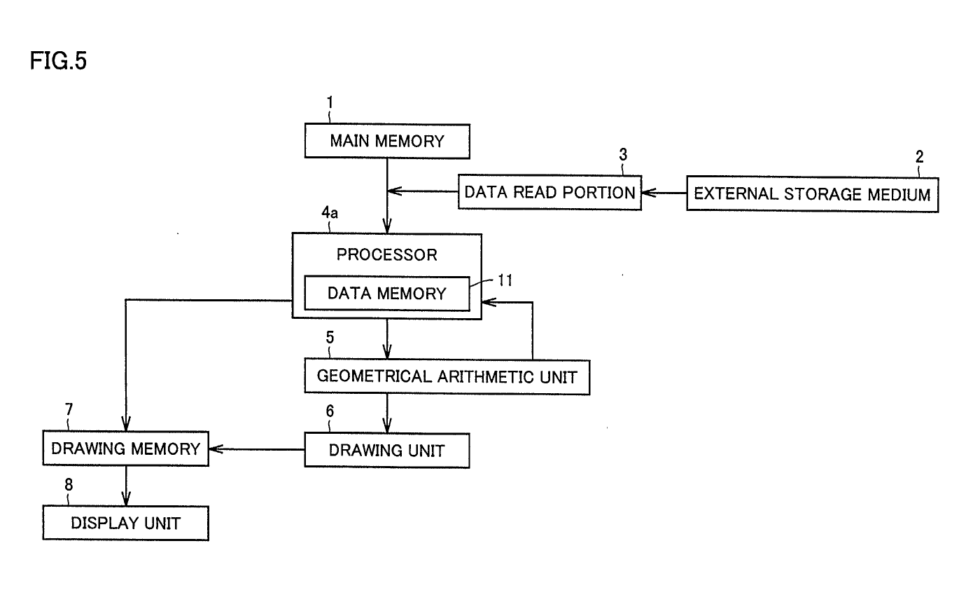

FIG. 5 is a block diagram showing a schematic structure of a graphics drawing device of a third embodiment of the invention. The graphics drawing device of this embodiment differs from the graphics drawing device of the first embodiment shown in FIG. 2 only in the structure of the processor. Accordingly, description of the same structures and functions is not repeated. In the following description of this embodiment, the processor is indicated by a reference number 4a.

Processor 4a includes data memory 11 for temporarily storing drawing data read from external storage medium 2. Processor 4a temporarily stores the drawing data, which is read via data read portion 3, in data memory 11. Processor 4a appropriately reads the drawing data from data memory 11, and transfers it to geometrical arithmetic unit 5. Further, processor 4a receives a command corresponding to the non-rotation target drawing data from geometrical arithmetic unit 5, and thereby reads the non-rotation target drawing data stored in data memory 11 for transferring it to drawing memory 7.

According to the graphics drawing device of this embodiment, as described above, the drawing data is read from external storage medium 2, and is temporarily stored in data memory 11. Therefore, the subsequent access for the drawing data is made to data memory 11 so that fast reading of the drawing data can be performed. Compared with the graphics drawing device of the first embodiment, therefore, the drawing processing speed can be further improved, and the drawing processing can be performed further smoothly.

(Fourth Embodiment)

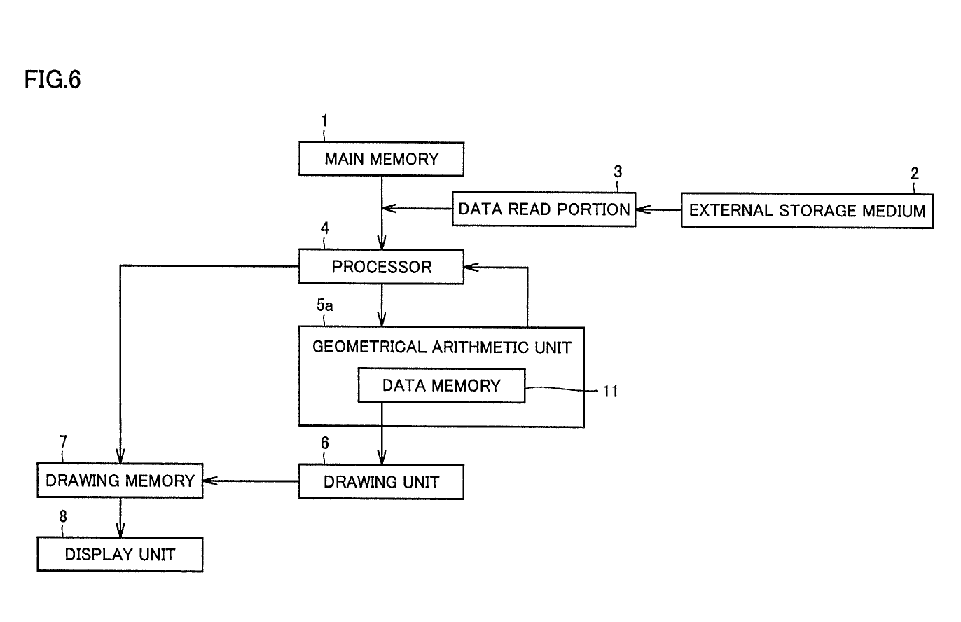

FIG. 6 is a block diagram showing a schematic structure of a graphics drawing device of a fourth embodiment of the invention. The graphics drawing device of this embodiment differs from the graphics drawing device of the first embodiment shown in FIG. 2 only in the structure of the geometrical arithmetic unit. Accordingly, description of the same structures and functions is not repeated. In the following description of this embodiment, the geometrical arithmetic unit is indicated by a reference number 5a.

Geometrical arithmetic unit 5a includes data memory 11 for temporarily storing drawing data read from external storage medium 2. Processor 4 temporarily stores the drawing data, which is read via data read portion 3, in data memory 11. Also, processor 4 appropriately instructs geometrical arithmetic unit 5a to read the drawing data from data memory 11, and receives a command corresponding to the non-rotation target drawing data from geometrical arithmetic unit 5a so that processor 4 reads the non-rotation target drawing data stored in data memory 11, and transfers it to drawing memory 7.

According to the graphics drawing device of this embodiment, as described above, the drawing data is read from external storage medium 2, and is temporarily stored in data memory 11. Therefore, the subsequent access for the drawing data is made to data memory 11 so that fast reading of the drawing data can be performed. Since geometrical arithmetic unit 5a can read the drawing data directly from data memory 11 in accordance with the instruction sent from processor 4, it can rapidly obtain the drawing data. Compared with the graphics drawing device of the first embodiment, therefore, the drawing processing speed can be further improved, and the drawing processing can be performed further smoothly.

(Fifth Embodiment)

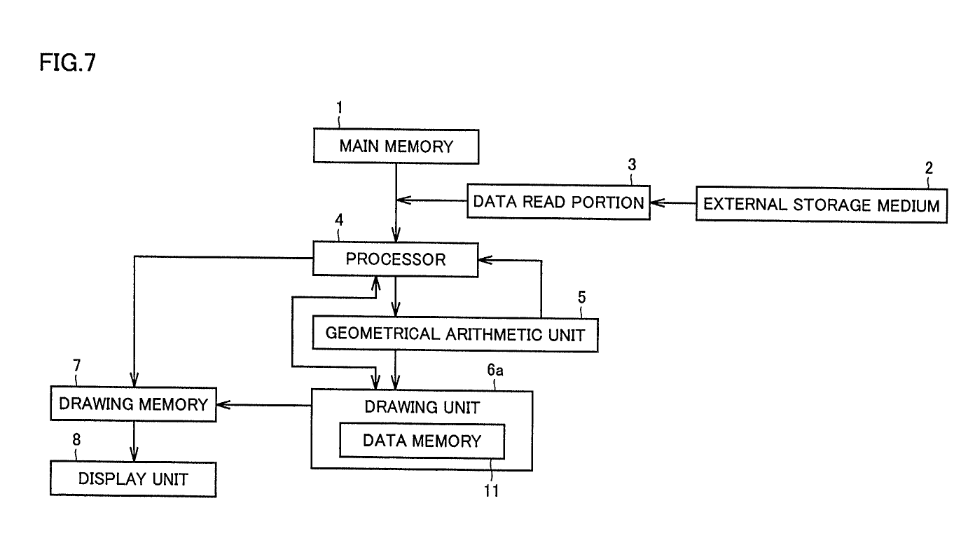

FIG. 7 is a block diagram showing a schematic structure of a graphics drawing device of a fifth embodiment of the invention. The graphics drawing device of this embodiment differs from the graphics drawing device of the first embodiment shown in FIG. 2 only in the structure of the drawing unit. Accordingly, description of the same structures and functions is not repeated. In the following description of this embodiment, the drawing unit is indicated by a reference number 6a.

Drawing unit 6a includes data memory 11 for temporarily storing drawing data read from external storage medium 2. Processor 4 temporarily stores the drawing data, which is read via data read portion 3, in data memory 11. Processor 4 appropriately reads the drawing data from data memory 11, and transfers it to geometrical arithmetic unit 5. Further, processor 4 receives a command corresponding to the non-rotation target drawing data from geometrical arithmetic unit 5, and thereby reads the non-rotation target drawing data stored in data memory 11 for transferring it to drawing memory 7.

According to the graphics drawing device of this embodiment, as described above, the drawing data is read from external storage medium 2, and is temporarily stored in data memory 11. Therefore, the subsequent access for the drawing data is made to data memory 11 so that fast reading of the drawing data can be performed. Compared with the graphics drawing device of the first embodiment, therefore, the drawing processing speed can be further improved, and the drawing processing can be performed further smoothly.

(Sixth Embodiment)

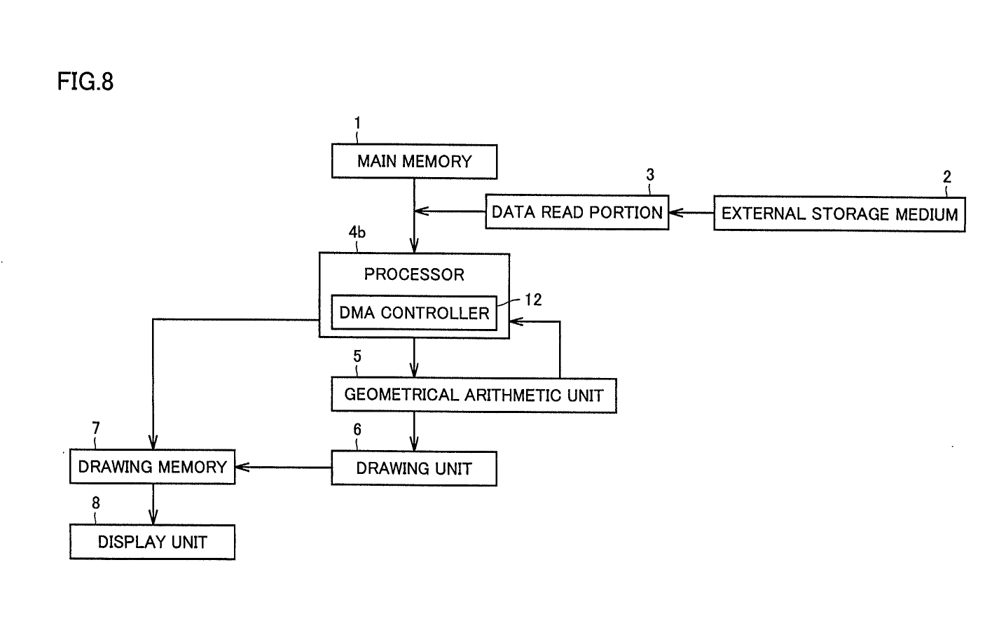

FIG. 8 is a block diagram showing a schematic structure of a graphics drawing device of a sixth embodiment of the invention. The graphics drawing device of this embodiment differs from the graphics drawing device of the first embodiment shown in FIG. 2 only in the structure of the processor. Accordingly, description of the same structures and functions is not repeated. In the following description of this embodiment, the processor is indicated by reference number 4b.

Processor 4b includes a DMA (Direct Memory Access) controller 12 for transferring drawing data, which is read by data read portion 3, directly to geometrical arithmetic unit 5 or drawing memory 7. Processor 4b sets DMA controller 12 such that the rotation target drawing data to be transferred to geometrical arithmetic unit 5 may be transferred from data read portion 3 directly to geometrical arithmetic unit 5. Processor 4b also sets DMA controller 12 such that the non-rotation target drawing data to be transferred to drawing memory 7 may be transferred from data read portion 3 directly to drawing memory 7.

According to the graphics drawing device of this embodiment, as described above, processor 4b controls DMA controller 12 to transfer the drawing data from data read portion 3 directly to geometrical arithmetic unit 5 or drawing memory 7. Therefore, it is possible to reduce a processing load on processor 4b. Compared with the graphics drawing device of the first embodiment, therefore, the drawing processing speed can be further improved, and the drawing processing can be performed further smoothly.

(Seventh Embodiment)

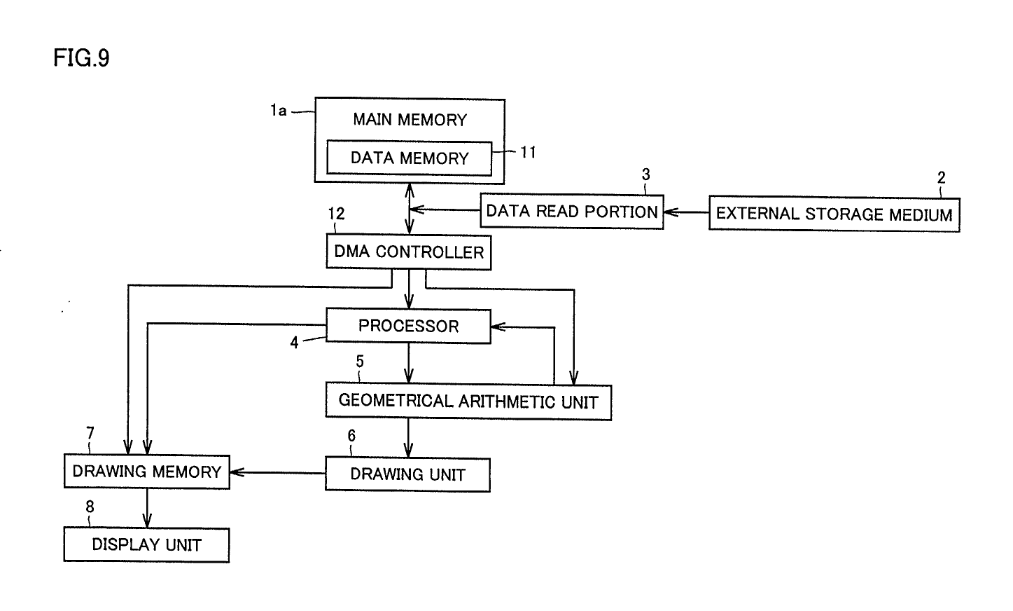

FIG. 9 is a block diagram showing a schematic structure of a graphics drawing device of a seventh embodiment of the invention. The graphics drawing device of this embodiment differs from the graphics drawing device of the first embodiment shown in FIG. 2 only in the structure of the main memory, and that DMA controller 12 is arranged between the main memory and processor 4. Accordingly, description of the same structures and functions is not repeated. In the following description of this embodiment, the main memory is indicated by a reference number 1a.

Main memory 1a includes data memory 11 for temporarily storing drawing data sent from external storage medium 2, in addition to the region for storing a program to be executed by processor 4. DMA processor 12 transfers the drawing data, which is read from external storage medium 2, directly to data memory 11 in accordance with the instruction sent from processor 4.

Processor 4 sets DMA controller 12 such that the rotation target drawing data to be transferred to geometrical arithmetic unit 5 may be transferred from data memory 11 directly to geometrical arithmetic unit 5. Processor 4 receives a command corresponding to the non-rotation target drawing data from geometrical arithmetic unit 5b, and sets DMA controller 12 such that the non-rotation target drawing data to be transferred to drawing memory 7 may be transferred from data memory 11 directly to drawing memory 7.

According to the graphics drawing device of this embodiment, as described above, processor 4 controls DMA controller 12 to transfer the drawing data from data read portion 3 directly to data memory 11. Therefore, the subsequent access for the drawing data is made to data memory 11 so that fast reading of the drawing data can be performed. Compared with the graphics drawing device of the sixth embodiment, therefore, the drawing processing speed can be further improved, and the drawing processing can be performed further smoothly.

(Eighth Embodiment)

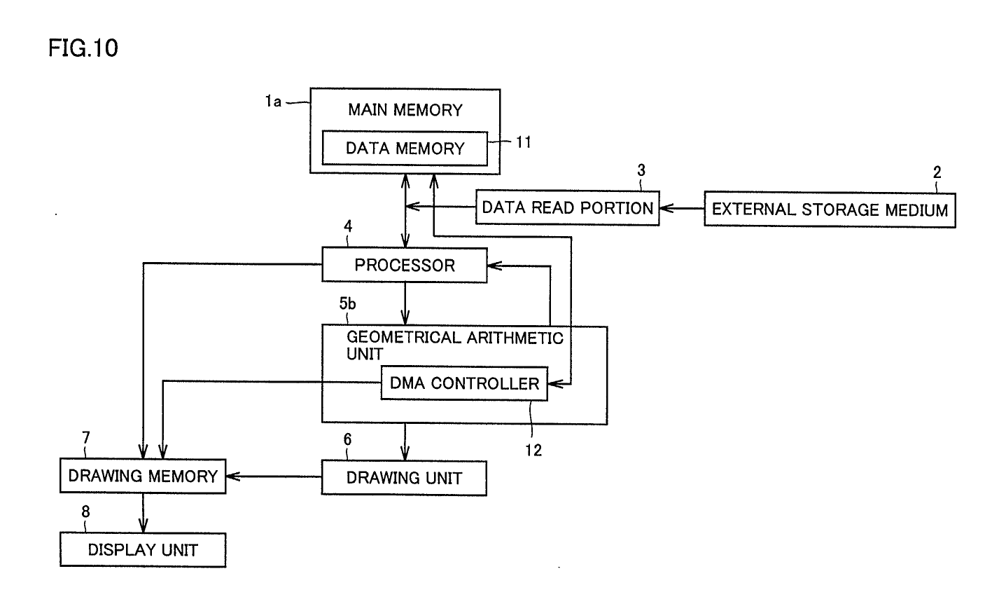

FIG. 10 is a block diagram showing a schematic structure of a graphics drawing device of an eighth embodiment of the invention. The graphics drawing device of this embodiment differs from the graphics drawing device of the first embodiment shown in FIG. 2 only in the structures of the main memory and the geometrical arithmetic unit. Accordingly, description of the same structures and functions is not repeated. In the following description of this embodiment, the main memory and the geometrical arithmetic unit are indicated by reference numbers 1a and 5b, respectively.

Main memory 1a includes data memory 11 for temporarily storing drawing data read from external storage medium 2, in addition to the region for storing a program to be executed by processor 4. DMA controller 12 transfers the drawing data, which is read from external storage medium 2, directly to data memory 11 in accordance with the instruction sent from processor 4.

Processor 4 sets DMA controller 12 such that the rotation target drawing data to be transferred to geometrical arithmetic unit 5b may be transferred from data memory 11 directly to geometrical arithmetic unit 5b. Processor 4 receives a command corresponding to the non-rotation target drawing data from geometrical arithmetic unit 5b, and sets DMA controller 12 such that the non-rotation target drawing data to be transferred to drawing memory 7 may be transferred from data memory 11 directly to drawing memory 7.

According to the graphics drawing device of this embodiment, as described above, processor 4 controls DMA controller 12 to transfer the drawing data from data read portion 3 directly to data memory 11. Therefore, the subsequent access for the drawing data is made to data memory 11 so that fast reading of the drawing data can be performed. Compared with the graphics drawing device of the sixth embodiment, therefore, the drawing processing speed can be further improved, and the drawing processing can be performed further smoothly.

(Ninth Embodiment)

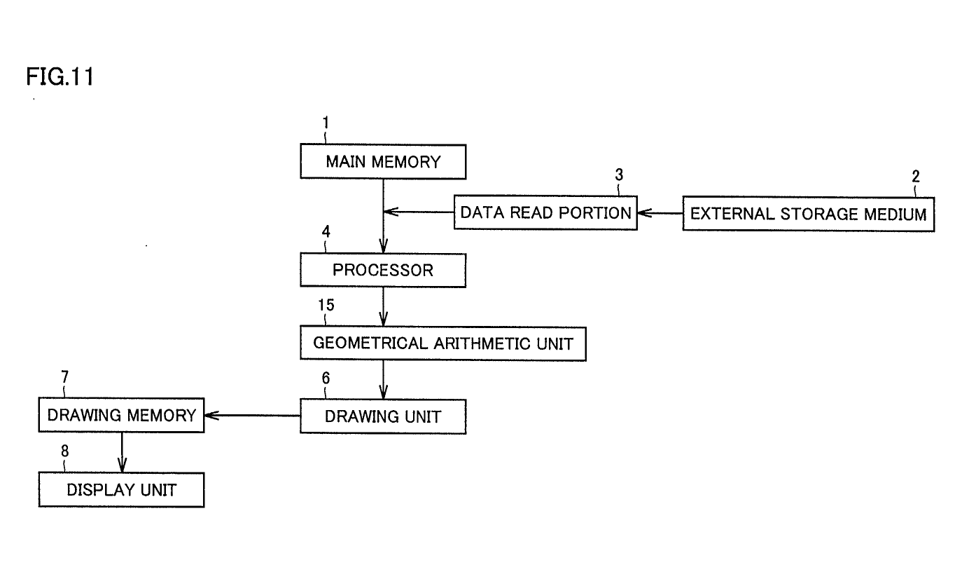

FIG. 11 is a block diagram showing a schematic structure of a graphics drawing device of a ninth embodiment of the invention. The graphics drawing device includes main memory 1 for storing programs and others, data read portion 3 for reading drawing data from external storage medium 2, processor 4 for executing the program stored in main memory 1 to perform a series of processing, a geometrical arithmetic unit 15 for performing geometrical arithmetic processing such as rotation and coordinate transformation on the drawing data sent from processor 4, drawing unit 6 for performing a series of drawing processing based on vertex data, which is output from geometrical arithmetic unit 15 after being subjected to the arithmetic processing, drawing memory 7 for storing, as frame images, pixel data and others produced by drawing unit 6, and display unit 8 for displaying the pixel data stored in drawing memory 7.

It is assumed that the graphics drawing device of the embodiment uses the rotation target drawing data, all of which are represented as 3-D drawing data and thus are represented by X-, Y- and Z-coordinate values.

Processor 4 transfers the drawing data and viewpoint information read by data read portion 3 to geometrical arithmetic unit 15. Geometrical arithmetic unit 15 sets a predetermined value, e.g., of “0” in the Z-coordinate value of 3-D drawing data. Geometrical arithmetic unit 15 performs a series of two-dimensional projection arithmetic such as coordinate transformation based on the drawing data and the view information, and transfers the display coordinate data to drawing unit 6.

If the drawing data output from geometrical arithmetic unit 15 is the rotation target drawing data, drawing unit 6 produces pixel data of each polygon forming a primitive based on the display coordinate data of the rotation target drawing data, and writes it into drawing memory 7. If drawing data output from geometrical arithmetic unit 15 is the non-rotation target drawing data, drawing unit 6 reads the non-rotation target drawing data via data read portion 3, and transfers the non-rotation target drawing data to the region of drawing memory 7 corresponding to the display coordinate data. When drawing unit 6 writes the pixel data corresponding to the drawing data for one frame, display unit 8 reads out the pixel data from drawing memory 7, and successively displays it.

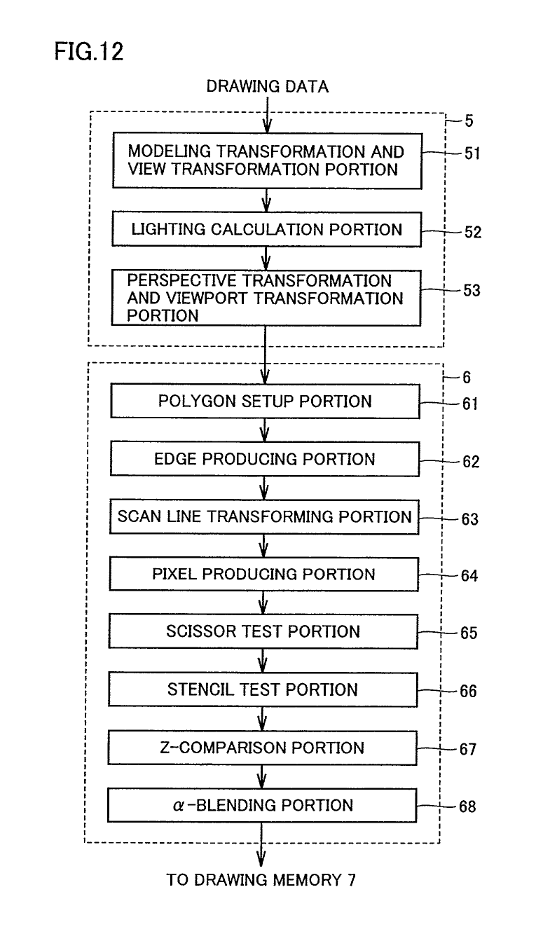

FIG. 12 is a block diagram showing schematic structures of geometrical arithmetic unit 15 and drawing unit 6 of the ninth embodiment of the invention. Geometrical arithmetic unit 15 differs from geometrical arithmetic unit 5 of the first embodiment shown in FIG. 3 only in that the non-rotation drawing data detecting portion 54 is eliminated. Accordingly, description of the same structures and functions is not repeated.

According to the graphics drawing device of this embodiment, as described above, the coordinate transformation and other processing are performed by geometrical arithmetic unit 15 after setting the Z-coordinate value of 3-D drawing data to the predetermined value so that processor 4 and drawing unit 6 can perform the processing in parallel. Therefore, the drawing processing speed can be improved, and the drawing processing can be performed smoothly.

(Tenth Embodiment)

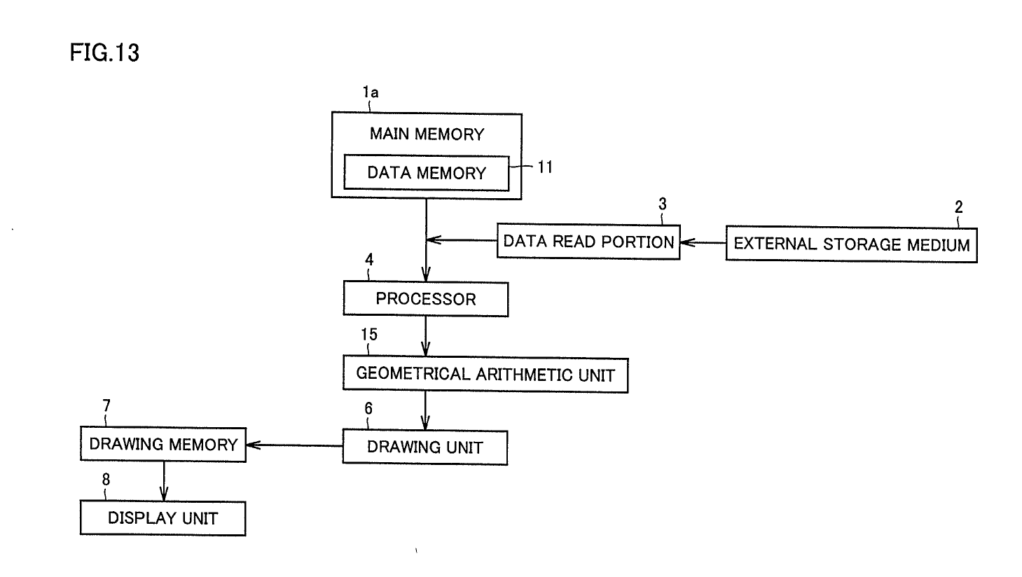

FIG. 13 is a block diagram showing a schematic structure of a graphics drawing device of a tenth embodiment of the invention. The graphics drawing device of this embodiment differs from the graphics drawing device of the ninth embodiment shown in FIG. 11 only in the structure of the main memory. Accordingly, description of the same structures and functions is not repeated. In the following description of this embodiment, the main memory is indicated by reference number 1a.

Main memory 1a includes data memory 11 for temporarily storing drawing data read from external storage medium 2, in addition to the region for storing a program to be executed by processor 4. Processor 4 temporarily stores the drawing data, which is read via data read portion 3, in data memory 11. Processor 4 appropriately reads the drawing data from data memory 11, and transfers it to geometrical arithmetic unit 15.

According to the graphics drawing device of this embodiment, as described above, the drawing data is read from external storage medium 2, and is temporarily stored in data memory 11. Therefore, the subsequent access for the drawing data is made to data memory 11 so that fast reading of the drawing data can be performed. Compared with the graphics drawing device of the ninth embodiment, therefore, the drawing processing speed can be further improved, and the drawing processing can be performed further smoothly.

(Eleventh Embodiment)

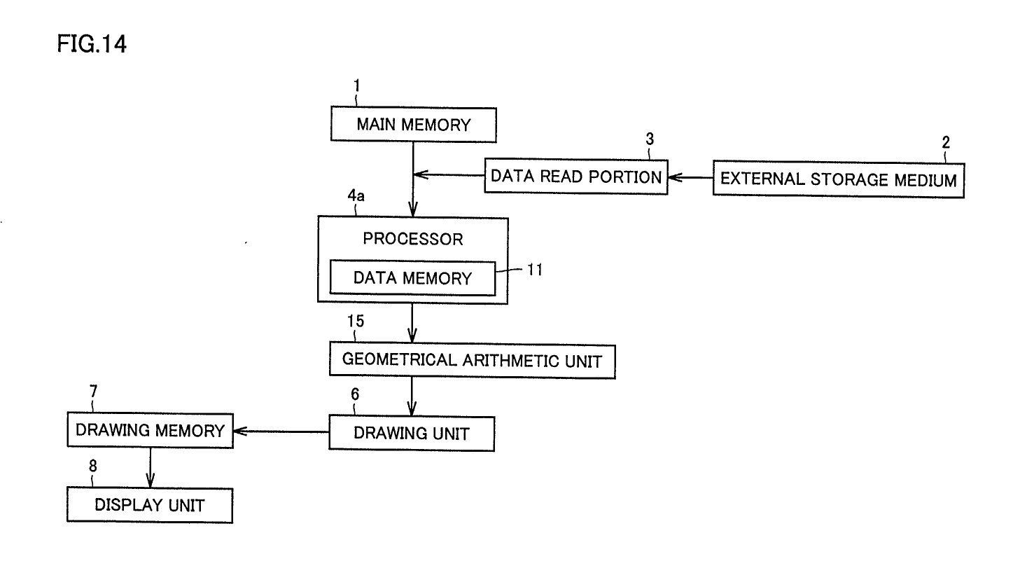

FIG. 14 is a block diagram showing a schematic structure of a graphics drawing device of an eleventh embodiment of the invention. The graphics drawing device of this embodiment differs from the graphics drawing device of the ninth embodiment shown in FIG. 11 only in the structure of the processor. Accordingly, description of the same structures and functions is not repeated. In the following description of this embodiment, the processor is indicated by reference number 4a.

Processor 4a includes data memory 11 for temporarily storing drawing data read from external storage medium 2. Processor 4a temporarily stores the drawing data, which is read via data read portion 3, in data memory 11. Processor 4a appropriately reads the drawing data from data memory 11, and transfers it to geometrical arithmetic unit 15.

According to the graphics drawing device of this embodiment, as described above, the drawing data is read from external storage medium 2, and is temporarily stored in data memory 11. Therefore, the subsequent access for the drawing data is made to data memory 11 so that fast reading of the drawing data can be performed. Compared with the graphics drawing device of the ninth embodiment, therefore, the drawing processing speed can be further improved, and the drawing processing can be performed further smoothly.

(Twelfth Embodiment)

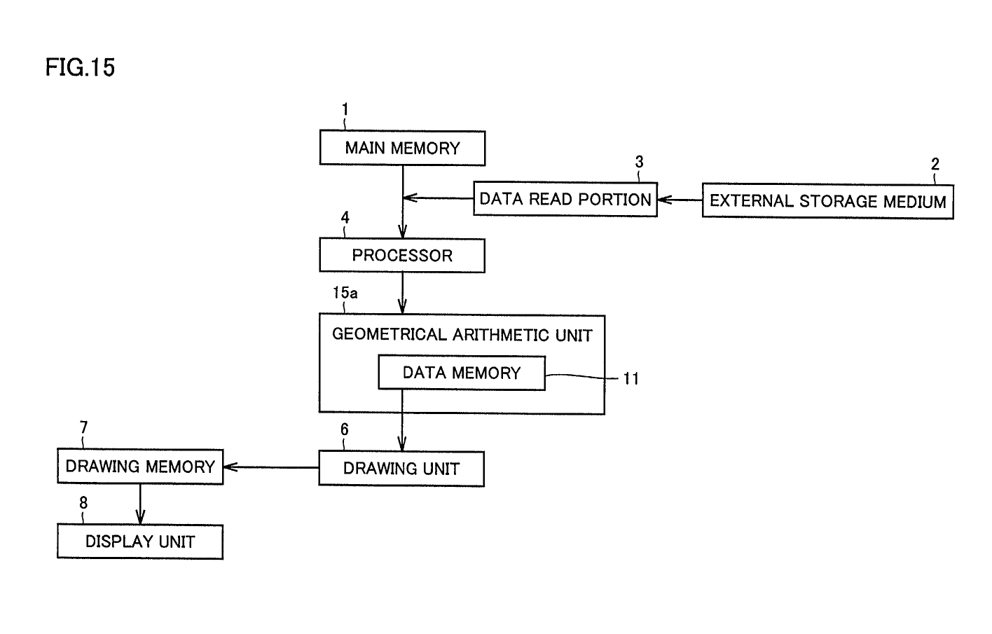

FIG. 15 is a block diagram showing a schematic structure of a graphics drawing device of a twelfth embodiment of the invention. The graphics drawing device of this embodiment differs from the graphics drawing device of the ninth embodiment shown in FIG. 11 only in the structure of the geometrical arithmetic unit. Accordingly, description of the same structures and functions is not repeated. In the following description of this embodiment, the geometrical arithmetic unit is indicated by a reference number 15a.

Geometrical arithmetic unit 15a includes data memory 11 for temporarily storing drawing data read from external storage medium 2. Processor 4 temporarily stores the drawing data, which is read via data read portion 3, in data memory 11. Also, processor 4 appropriately instructs geometrical arithmetic unit 15a to read the drawing data from data memory 11.

According to the graphics drawing device of this embodiment, as described above, the drawing data is read from external storage medium 2, and is temporarily stored in data memory 11. Therefore, the subsequent access for the drawing data is made to data memory 11 so that fast reading of the drawing data can be performed. Since geometrical arithmetic unit 15a can read the drawing data directly from data memory 11 in accordance with the instruction sent from processor 4, it can rapidly obtain the drawing data. Compared with the graphics drawing device of the ninth embodiment, therefore, the drawing processing speed can be further improved, and the drawing processing can be performed further smoothly.

(Thirteenth Embodiment)

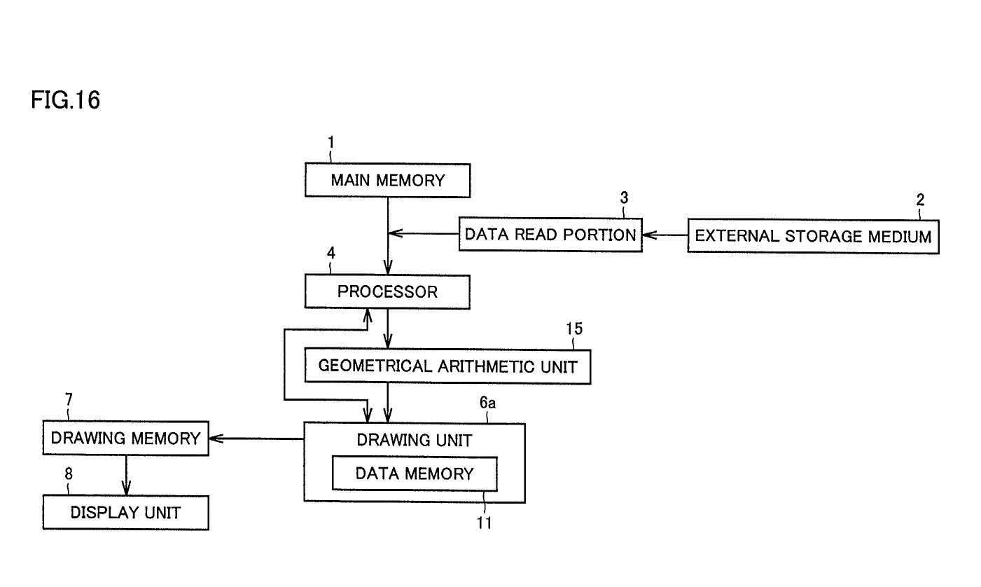

FIG. 16 is a block diagram showing a schematic structure of a graphics drawing device of a thirteenth embodiment of the invention. The graphics drawing device of this embodiment differs from the graphics drawing device of the ninth embodiment shown in FIG. 11 only in the structure of the drawing unit. Accordingly, description of the same structures and functions is not repeated. In the following description of this embodiment, the drawing unit is indicated by reference number 6a.

Drawing unit 6a includes data memory 11 for temporarily storing drawing data read from external storage medium 2. Processor 4 temporarily stores the drawing data, which is read via data read portion 3, in data memory 11. Processor 4 appropriately reads the drawing data from data memory 11, and transfers it to geometrical arithmetic unit 15.

According to the graphics drawing device of this embodiment, as described above, the drawing data is read from external storage medium 2, and is temporarily stored in data memory 11. Therefore, the subsequent access for the drawing data is made to data memory 11 so that fast reading of the drawing data can be performed. Compared with the graphics drawing device of the ninth embodiment, therefore, the drawing processing speed can be further improved, and the drawing processing can be performed further smoothly.

(Fourteenth Embodiment)

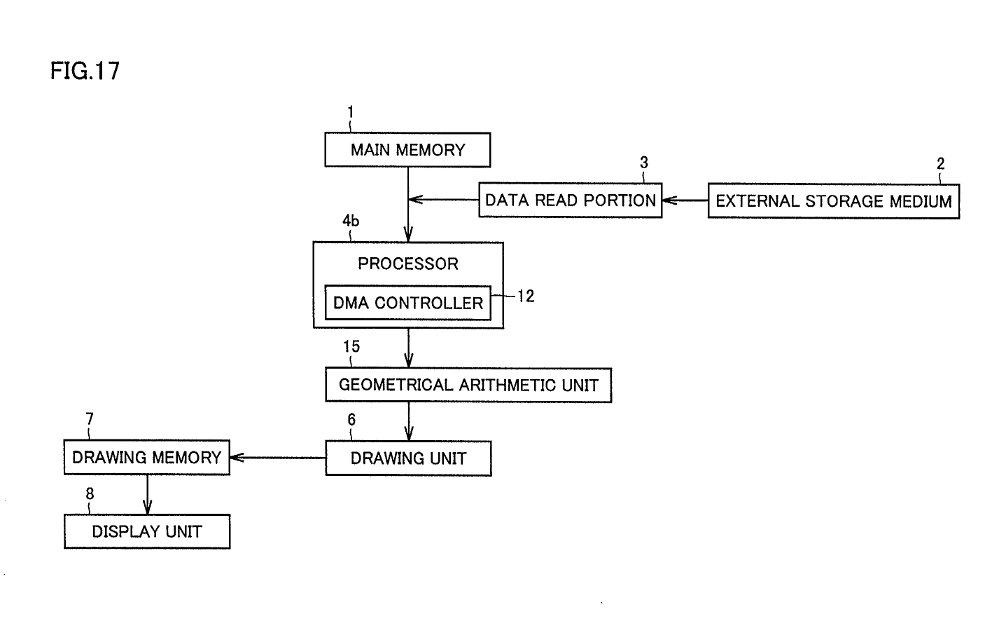

FIG. 17 is a block diagram showing a schematic structure of a graphics drawing device of a fourteenth embodiment of the invention. The graphics drawing device of this embodiment differs from the graphics drawing device of the ninth embodiment shown in FIG. 11 only in the structure of the processor. Accordingly, description of the same structures and functions is not repeated. In the following description of this embodiment, the processor is indicated by reference number 4b.

Processor 4b includes DMA controller 12 for transferring drawing data, which is read by data read portion 3, directly to geometrical arithmetic unit 15. Processor 4b sets DMA controller 12 such that the drawing data to be transferred to geometrical arithmetic unit 15 may be transferred from data read portion 3 directly to geometrical arithmetic unit 15.

According to the graphics drawing device of this embodiment, as described above, processor 4b controls DMA controller 12 to transfer the drawing data from data read portion 3 directly to geometrical arithmetic unit 15. Therefore, it is possible to reduce a processing load on processor 4b. Compared with the graphics drawing device of the first embodiment, therefore, the drawing processing speed can be further improved, and the drawing processing can be performed further smoothly.

(Fifteenth Embodiment)

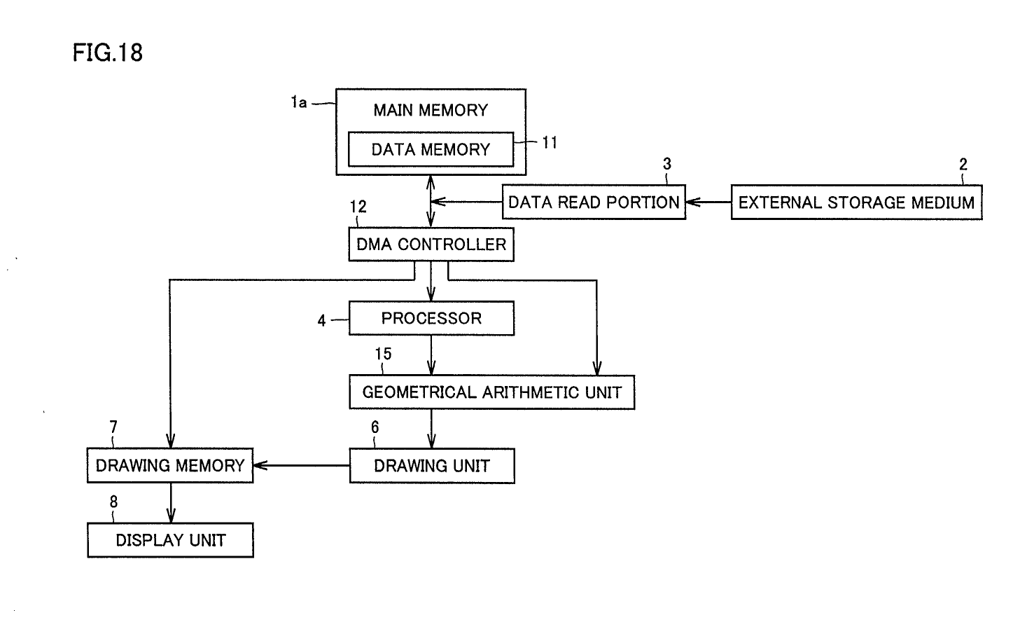

FIG. 18 is a block diagram showing a schematic structure of a graphics drawing device of a fifteenth embodiment of the invention. The graphics drawing device of this embodiment differs from the graphics drawing device of the ninth embodiment shown in FIG. 11 only in the structure of the main memory, and that DMA controller 12 is arranged between the main memory and processor 4. Accordingly, description of the same structures and functions is not repeated. In the following description of this embodiment, the main memory is indicated by reference number 1a.

Main memory 1a includes data memory 11 for temporarily storing drawing data read from external storage medium 2, in addition to the region for storing a program to be executed by processor 4. DMA controller 12 transfers the drawing data, which is read from external storage medium 2, directly to data memory 11 in accordance with the instruction sent from processor 4.

Processor 4 sets DMA controller 12 such that the drawing data to be transferred to geometrical arithmetic unit 15 may be transferred from data memory 11 directly to geometrical arithmetic unit 15.

According to the graphics drawing device of this embodiment, as described above, processor 4 controls DMA controller 12 to transfer the drawing data from data read portion 3 directly to data memory 11. Therefore, the subsequent access for the drawing data is made to data memory 11 so that fast reading of the drawing data can be performed. Compared with the graphics drawing device of the fourteenth embodiment, therefore, the drawing processing speed can be further improved, and the drawing processing can be performed further smoothly.

(Sixteenth Embodiment)

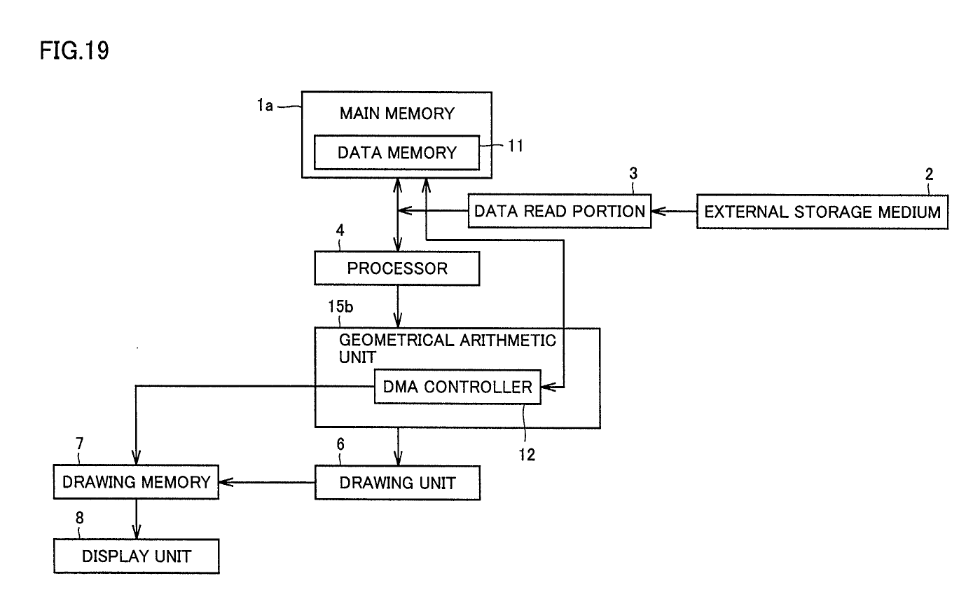

FIG. 19 is a block diagram showing a schematic structure of a graphics drawing device of a sixteenth embodiment of the invention. The graphics drawing device of this embodiment differs from the graphics drawing device of the ninth embodiment shown in FIG. 11 only in the structures of the main memory and the geometrical arithmetic unit. Accordingly, description of the same structures and functions is not repeated. In the following description of this embodiment, the main memory and the geometrical arithmetic unit are indicated by reference numbers 1a and 15b, respectively.

Main memory 1a includes data memory 11 for temporarily storing drawing data sent from external storage medium 2, in addition to the region for storing a program to be executed by processor 4. DMA processor 12 transfers the drawing data, which is read from external storage medium 2, directly to data memory 11 in accordance with the instruction sent from processor 4.

Processor 4 sets DMA controller 12 such that the drawing data to be transferred to geometrical arithmetic unit 15b may be transferred from data memory 11 directly to geometrical arithmetic unit 15b.

According to the graphics drawing device of this embodiment, as described above, processor 4 controls DMA controller 12 to transfer the drawing data from data read portion 3 directly to data memory 11. Therefore, the subsequent access for the drawing data is made to data memory 11 so that fast reading of the drawing data can be performed. Compared with the graphics drawing device of the fourteenth embodiment, therefore, the drawing processing speed can be further improved, and the drawing processing can be performed further smoothly.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A graphics drawing device for drawing graphics from drawing data including rotation target drawing data and non-rotation target drawing data, comprising:
a drawing memory storing an image to be drawn on a screen;
a processor controlling transfer of an image of said non-rotation target drawing data to said drawing memory based on display coordinate data;
a drawing unit producing a rotated image based on said rotation target drawing data, and transferring the rotated image to said drawing memory based on the display coordinate data;
a geometrical arithmetic unit obtaining the display coordinate data by coordinate transformation of the drawing data, transferring the display coordinate data to said drawing unit when said drawing data is the rotation target drawing data, and transferring the display coordinate data to said processor when said drawing data is the non-rotation target drawing data; and
a display unit displaying the image stored in said drawing memory on the screen.

2. The graphics drawing device according to claim 1, further comprising:
a data read portion reading the drawing data stored in an external storage medium, wherein
said processor transfers the drawing data read by said data read portion to said geometrical arithmetic unit.

3. The graphics drawing device according to claim 1, further comprising:
a data read portion reading the drawing data stored in an external storage medium; and
a data memory storing the drawing data read by said data read portion, wherein
said processor transfers the drawing data stored in said data memory to said geometrical arithmetic unit.

4. The graphics drawing device according to claim 3, wherein
said data memory is arranged within said processor.

5. The graphics drawing device according to claim 3, wherein
said data memory is arranged within said geometrical arithmetic unit.

6. The graphics drawing device according to claim 3, wherein
said data memory is arranged within said drawing unit.

7. The graphics drawing device according to claim 1, further comprising:
a data read portion reading the drawing data stored in an external storage medium; and
a direct memory access controller transferring the drawing data read by said data read portion to said geometrical arithmetic unit or said drawing memory.

8. The graphics drawing device according to claim 7, wherein said direct memory access controller is arranged within said processor.

9. The graphics drawing device according to claim 1, further comprising:
a data read portion reading the drawing data stored in an external storage medium;
a data memory storing the drawing data read by said data read portion; and
a direct memory access controller transferring the drawing data read by said data read portion to said data memory, and transferring the drawing data from said data memory to said geometrical arithmetic unit or said drawing memory.

10. The graphics drawing device according to claim 9, wherein said direct memory access controller is arranged within said geometrical arithmetic unit.

11. A graphics drawing device for drawing graphics from drawing data including rotation target drawing data and non-rotation target drawing data, comprising:
a drawing memory storing an image to be drawn on a screen;
a geometrical arithmetic unit setting a Z-coordinate value of said drawing data to a predetermined value, and thereafter obtaining display coordinate data by coordinate transformation;
a drawing unit producing a rotated image based on said rotation target drawing data, and transferring said rotated image to said drawing memory based on said display coordinate data when said drawing data is the rotation target drawing data, and
transferring an image corresponding to said non-rotation target drawing data to said drawing memory based on said display coordinate data when said drawing data is the non-rotation target drawing data; and
a display unit displaying the image stored in said drawing memory on the screen.

12. The graphics drawing device according to claim 11, further comprising:
a data read portion reading the drawing data stored in an external storage medium, and
a processor transferring the drawing data read by said data read portion to said geometrical arithmetic unit.

13. The graphics drawing device according to claim 11, further comprising:
a data read portion reading the drawing data stored in an external storage medium;
a data memory storing the drawing data read by said data read portion, and
a processor transferring the drawing data stored in said data memory to said geometrical arithmetic unit.

14. The graphics drawing device according to claim 13, wherein
said data memory is arranged within said processor.

15. The graphics drawing device according to claim 13, wherein
said data memory is arranged within said geometrical arithmetic unit.

16. The graphics drawing device according to claim 13, wherein
said data memory is arranged within said drawing unit.

17. The graphics drawing device according to claim 11, further comprising:
a data read portion reading the drawing data stored in an external storage medium; and
a direct memory access controller transferring the drawing data read by said data read portion to said geometrical arithmetic unit or said drawing memory.

18. The graphics drawing device according to claim 17, further comprising a processor for executing a program stored in a memory to perform a series of processing, wherein
said direct memory access controller is arranged within said processor.

19. The graphics drawing device according to claim 11, further comprising:
a data read portion reading the drawing data stored in an external storage medium;
a data memory storing the drawing data read by said data read portion; and
a direct memory access controller transferring the drawing data read by said data read portion to said data memory, and transferring the drawing data from said data memory to said geometrical arithmetic unit or said drawing memory.

20. The graphics drawing device according to claim 19, wherein
said direct memory access controller is arranged within said geometrical arithmetic unit.
